(19) United States
(12) Patent Application Publication
(10) Pub. No.: US 2008/0039007 A1
(43) Pub. Date: Feb. 14, 2008

(54) Multifunctional ultra wideband wireless transmission system

(75) Inventors: Ming-Hsiu Wu, Taipei City (TW); Liang I. Huang, Taipei City (TW); Hsin Hung Liu, Banciao City (TW)

Correspondence Address: TROXELL LAW OFFICE PLLC;SUITE 1404, 5205 LEESBURG PIKE, FALLS CHURCH, VA, 22041, US

(73) Assignee: Cameo Communications, Inc.

(21) Appl. No.: 11/494,596

(22) Filed: Jul. 28, 2006

(51) Int. Cl. H04H 1/00

(52) U.S. Cl. 455/3.01

(57) ABSTRACT

A multifunctional ultra wideband wireless transmission system having a base station and an ultra wideband wireless transceiver, wherein the base station having a means of wireless ultra wideband transmission provides a plurality of communication interfaces connecting to a plurality of peripheral devices of various interfaces, for example but not limited to: microphone, keyboard, mouse, CD/DVD ROM, printer, etc. The ultra wideband wireless transceiver is connected to a host for UWB signal transmission so that the ultra wideband interface can be used between the host and base station to transmit data or control instructions for control operations of peripheral devices. A functional keypad is disposed on the chassis of the base station. By pressing keys, the base station can operate connected peripheral devices.

### BACKGROUND OF INVENTION

1. Field of the Invention

The present invention relates to a multifunctional ultra wideband wireless transmission system, and more particularly to a multifunctional wireless transmission USB base station and transceiver using ultra wideband (UWB) technology to connect with a plurality of peripheral devices to eliminate the disorder of wired USB devices.

2. Description of the Prior Art

Portability, functionality, and operating convenience are increasingly the focus for of consumer electronic information products. Almost all product designers and manufacturers face a difficult choice of improving portability against sacrificing functionality to decrease the volume of products. This consideration is very important in designing products that often need various peripheral devices and have good portability, such as notebooks, personal digital assistants (PDA), smart phones, etc.

Traditionally, a universal serial bus (USB) connector is disposed on consumer electronic products, such as computers, to connect peripheral devices. Such a universal serial bus is a connection interface for computers and peripherals. The hot-plugging characteristic of USB enables the addition or removal of peripherals at anytime. The host automatically detects peripheral connection to ensure data integrity during use. For peripheral devices that support the USB interface, such as a personal digital assistant (PDA), flash memory, printer, keyboard, or mouse, connect to computers, to provide improved functionality. Through the USB standard interface, the computer and peripherals are effectively integrated. However, with so many USB-enabled devices available, cables are increasingly hard to manage because a physical wired connection is required. Furthermore, since the length of USB cables are limited, peripheral devices have to be placed within a close proximity, which is both inconvenient and undesirable.

TW patent publication No. I226551 has disclosed a multifunctional universal serial bus wireless bridge device and system whose main function is connecting multiple USB peripheral devices without cables. The USB hub is combined with wireless transmission so the host is not limited by physical connections, which broadens the communication and connection range. However, although the wireless USB hub of the prior art can effectively reduce the shortcoming of complex wiring, the connected objects are limited to peripheral devices supporting the USB interface.

### SUMMARY OF INVENTION

The primary object of the present invention is a multifunctional ultra wideband wireless transmission system connecting to a plurality of peripheral devices using various connection interfaces and protocols in a small and easy to carry host having a means of wireless transmission, and connecting to peripheral devices with various interfaces.

One embodiment of the multifunctional ultra wideband wireless transmission system in accordance with the present invention comprises: a base station and an ultra wideband wireless transceiver, wherein the base station having a means of wireless ultra wideband transmission provides a plurality of communication interfaces connecting to a plurality of peripheral devices of various interfaces, for example but not limited to: microphone, keyboard, mouse, CD/DVD ROM, printer, etc. The ultra wideband wireless transceiver is connected to a host for UWB signal transmission so that the ultra wideband interface can be used between the host and base station to transmit data or control instructions for control operations of peripheral devices. A functional keypad is disposed on the chassis of the base station. By pressing keys, the base station can operate connected peripheral devices.

### BRIEF DESCRIPTION OF THE DRAWINGS

The details of the present invention will be more readily understood from a detailed description of the preferred embodiments taken in conjunction with the following figures.

FIG. 1 is a diagram of a multifunctional ultra wideband wireless transmission device and peripheral connections of the present invention.

FIG. 2 is a block diagram of a base station and the connecting status blocks to each peripheral device of the present invention.

FIG. 3 is a block diagram of a base station, the connecting status blocks, and an external host 30 of the present invention.

FIG. 4 is a rear view of a preferred embodiment of the internal detailed structure of the base station of the present invention.

FIG. 5 is a block diagram of an ultra wideband wireless transceiver and the connecting status blocks to a host of the present invention.

FIG. 6 is a block diagram of a preferred embodiment of the ultra wideband wireless transceiver of the present invention.

### DETAILED DESCRIPTION

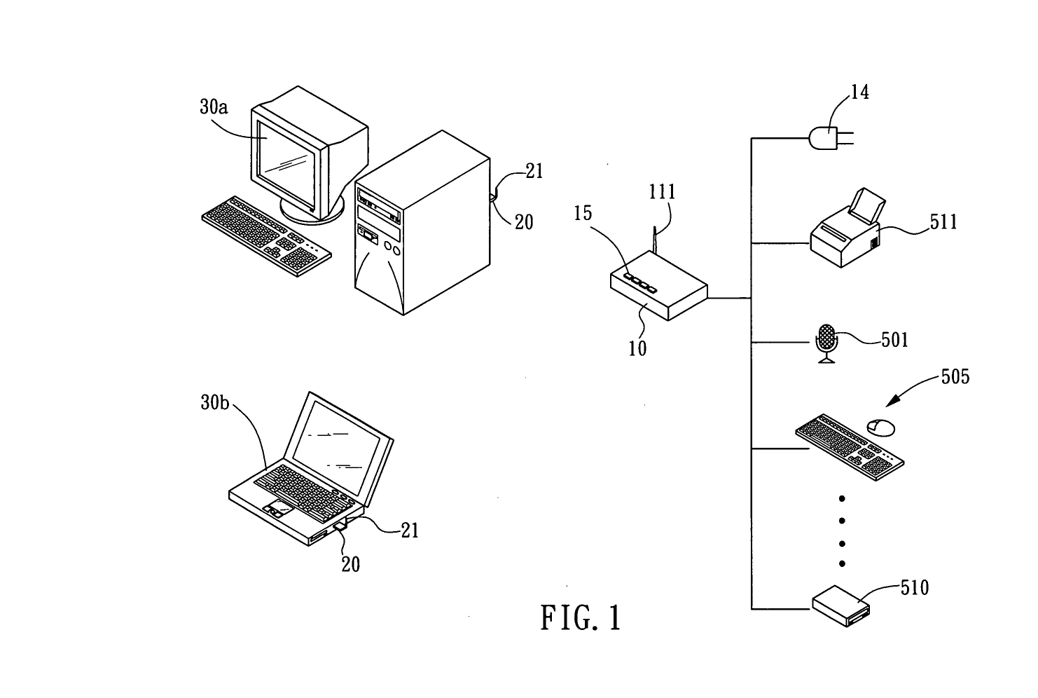

Referring to FIG. 1, the multifunctional ultra wideband wireless transmission system comprises: a multifunctional wireless transmission base station 10 (herein referred to as base station 10) and a wireless transmission transceiver 20 (herein referred to as transceiver 20). Base station 10 can be used to transmit signals of ultra wideband wireless UWB and convert to signals of other various peripheral interface devices. Transceiver 20 can be plugged into a host 30a (or 30b) and commence transmission of wireless UWB signals with base station 10.

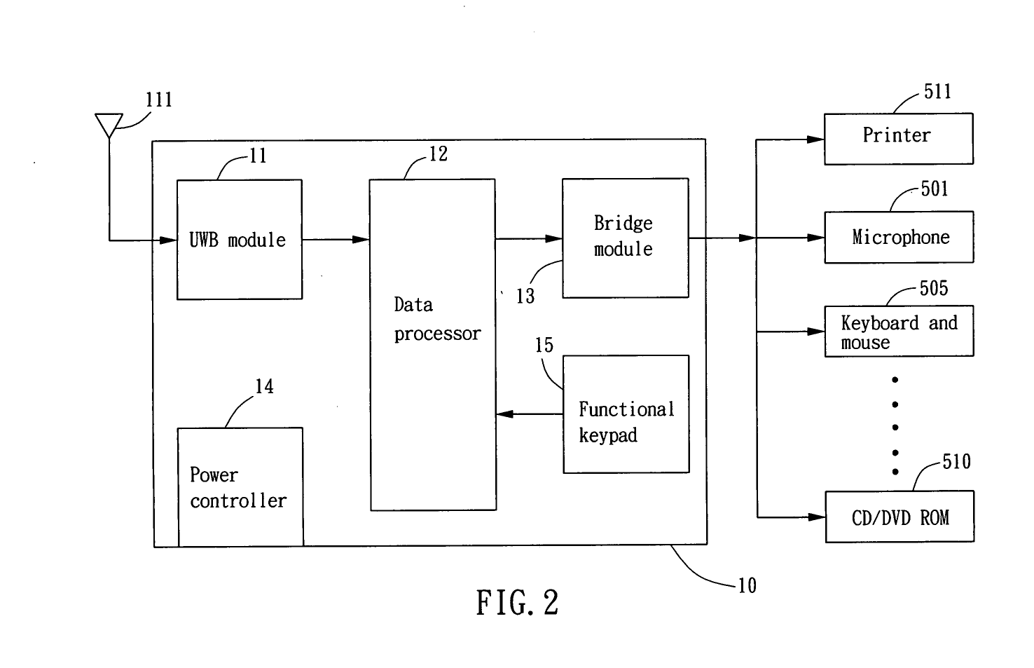

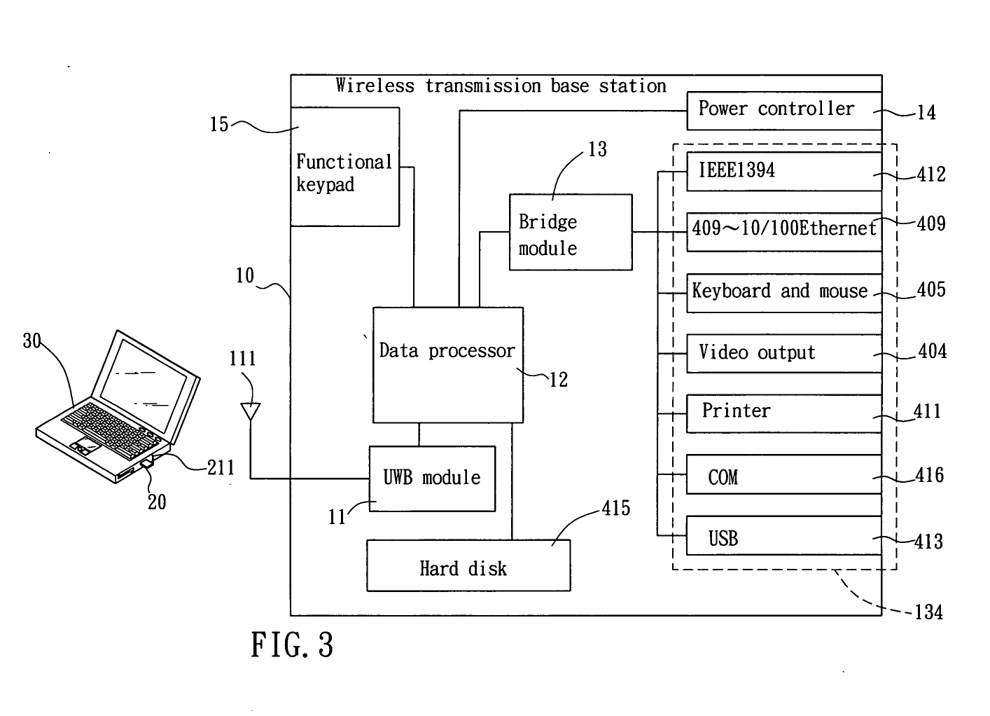

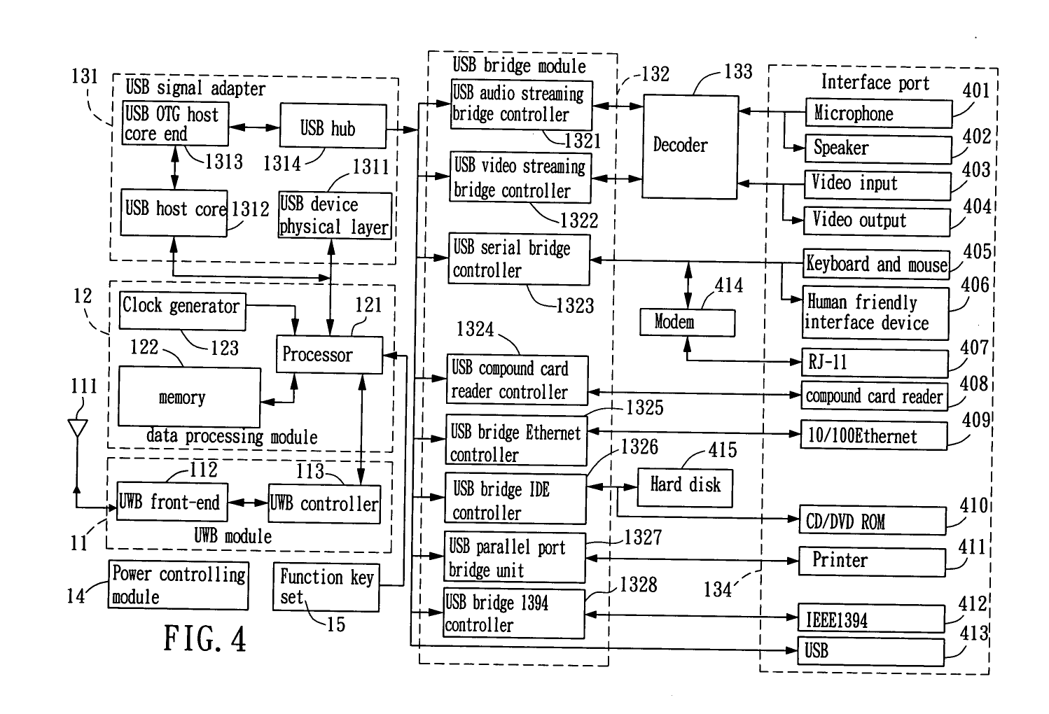

Please refer to FIG. 2, FIG. 3, and FIG. 4. FIG. 2 is a diagram of a basic structure of the base station and connection status blocks to each peripheral device of the present invention. FIG. 3 is a diagram of a basic structure of the base station and connection status blocks to an external host 30 of the present invention. FIG. 4 is a block diagram of a preferred embodiment of internal detailed structure of the base station of the present invention.

As shown in FIG. 1, FIG. 2 and FIG. 3, the base station 10 further comprises: an UWB module 11, a data processing module 12, a bridge module 13, a power controlling module 14, and a functional keypad 15.

As shown in FIG. 4, the UWB module 11 further comprises: an antenna 111, a UWB front-end 112, and a UWB controller 113. Antenna 111 can be extended and connected from base station 10 for strengthening wireless UWB signals. UWB front-end 112 is connected to antenna 111 for reduction of noise or strengthening the wireless signal for transmitting and receiving. UWB controller 113 is connected to UWB front-end 112 for data modulation and transmission or demodulating received signals back to data.

Data processing module 12 is physically connected between UWB module 11 and bridge module 13 whose main function is transmitting the control instructions needed by each module, or performing related operations and processing for base station 10. As shown in FIG. 4, data processing module 12 further comprises: a processor 121, a clock generator 123, and memory 122. Processor 121 is connected to bridge module 13 via a USB signal adaptor 131 for operating and processing received data and executing instructions needed by base station 10. Clock generator 123 is connected to processor 121 and decides operating speed of the processor. Memory unit 122 is electrically connected to processor 121. In the preferred embodiment, memory unit 122 can further comprise: a read only memory (ROM) or an Electrically Erasable Programmable ROM (EEPROM) connected to processor 121 for storing base station firmware data of the operational instruction set; and a random access memory (RAM) connected to processor 121 for the storing operational and registered data of processor 121, thereby increasing the operating speed of processor 121.

Bridge module 13 is connected to UWB module 11 through data processing module 12 for converting UWB signals to electrical signals to match multiple interfaces supported by each peripheral device. Base station 10 is capable of supporting at least a first protocol and a second protocol with different functions and interfaces, and these protocols can be converted to USB signals through the bridge module 13. As shown in FIG. 4, in the preferred embodiment, bridge module 13 further comprises: a USB signal adaptor 131, at least one USB bridge module 132, a decoder 133, and at least one interface port 134. USB signal adaptor 131 is connected to data processing module 12 for converting UWB signals to a USB communication format. At least one USB bridge module 132 converts wireless USB signals transmitted by USB signal adaptor 131 to various signal formats supported by each peripheral device. Decoder 133 is physically connected to USB bridge module 132 and speeds up multimedia format code conversion. The multimedia format codes can be MP3, JPEG, MP4, or other prior art multimedia code formats. At least one interface port 134 is physically connected to USB bridge module 132. USB bridge module 132 connects to a plurality of peripheral devices 501, 505, 510, 511, . . . as shown in FIG. 2 through the interface port 134.

USB signal adaptor 131 further comprises a USB device phy. 1311, a USB host core-ULPI 1312, a USB host OTG (On The Go) PHY-ULPI 1313, and a USB hub 1314. USB device phy. 1311 is connected to data processing module 12 and comprises memory for storing data therein. USB host core-ULPI 1312 is coupled to USB device phy. 1311 and processor 121 of data processing module 12 to control wireless USB signal transmission and reception. USB host OTG PHY-ULPI 1313 is connected to USB host core-ULPI 1312 whose main function is independently connecting and transmitting USB signals to operate USB peripheral devices. USB hub 1314 is coupled to the USB host OTG PHY-ULPI 1313, using a USB protocol to extend and connect more USB interfaces.

USB bridge module 132 is connected between USB hub 1314 and USB signal adaptor 131 whose main function is converting USB signals from USB signal adaptor 131 to corresponding electrical signals of various protocols and interfaces of each peripheral device. In the preferred embodiment, USB bridge module 132 can further comprise, but is not limited to: a USB audio streaming bridge controller 1321, a USB video streaming bridge controlling unit 1322, a USB serial bridge controller 1323, a USB compound card reader controlling unit 1324, a USB bridge Ethernet controlling unit 1325, a USB bridge IDE controller 1326, a USB parallel port bridge unit 1327, and a USB bridge 1394 controller 1328. The USB audio streaming bridge controller 1321 and USB video streaming bridge controller 1322 can proceed with conversion between USB protocol and video/audio protocol and can further use decoder 133 to speed up operation. USB serial bridge controller 1323, can convert between the USB and serial protocols, for example, a serial port. In addition, a modem module 414 can be further connected to USB serial bridge controller 1323 such that base station 10 of the present invention can choose the dial function of modem 414 to connect to the Internet or execute fax or telephone communication functions. USB compound card reader controller 1324 can convert between USB and memory card protocols, such as SD, CF, MMC, xD, etc. USB bridge Ethernet controller 1325 can convert between the USB and Ethernet protocols, for example TCP/IP. USB bridge IDE controller 1326 can convert between USB and IDE protocols and further connect to a physical hard disk 415 such that base station 10 of the present invention can additionally provide wireless UWB networked hard disk functions. Alternatively, video/audio data of multimedia format codes can be directly played by base station 10. USB parallel port bridge unit 1327 can convert between USB and parallel protocols, such as the parallel port, while USB bridge 1394 controller unit 1328 can convert between USB and 1394 protocols.

An interface port 134 is connected to USB bridge module 132 (or decoder 133), providing various protocols and connecting interfaces for connecting each external peripheral device. Interface port 134 can comprise but is not limited to: microphone 401 interface, speaker 402 interface, video input 403 interface, video output 404 interface, keyboard and mouse (such as PS2 or serial port) 405 interface, human friendly interface 406 (such as flight joystick), telephone line connecting interface 407 (such as RJ-11), card reader 408 interface for inserting memory cards, 10/100 Ethernet 409 interface, CD/DVD ROM drive (IDE) 410 interface, printer (LTP1) 411 interface, IEEE 1394 412 interface, and USB 415 interface for connecting additional USB peripheral devices.

A power controller 14 provides power to each module in base station 10. In the preferred embodiment, power controller 14 can further comprise: an alternating current/direct current converter for converting general alternating current (AC) to direct current (DC) power needed by base station 10, and a rectification unit connected to the AC/DC converter, preventing base station 10 from being damaged by unstable power. Power controller 14 can be an external module or built into base station 10 to provide needed power.

A functional keypad 15 is disposed on the periphery of base station 10 and further comprises: a fast setup key connected to data processing module 12 for controlling the frequency setup of base station 10, and a broadcast function key set connected to data processing module 12 which can be operated from base station 10 to activate multimedia files or to operate functions of peripheral devices, such as forward or backward whilst playing movies or instigate transmission of data from memory cards (not shown) plugged into card reader 408 or other peripheral devices attached to base station 10.

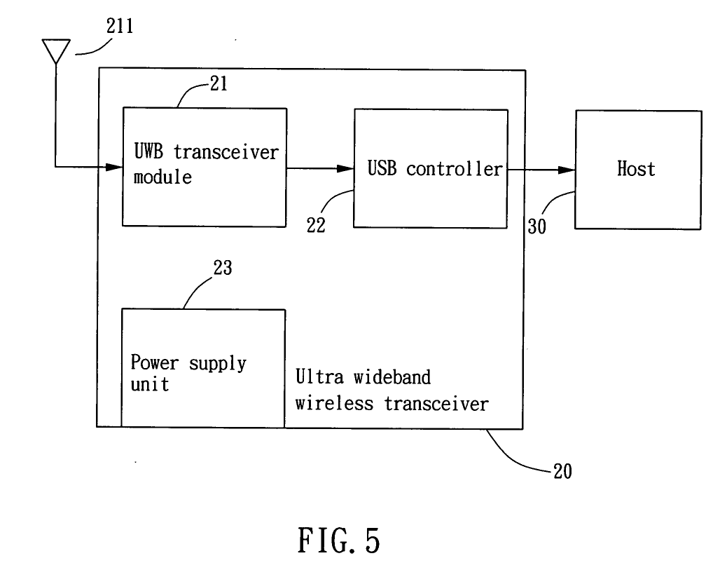

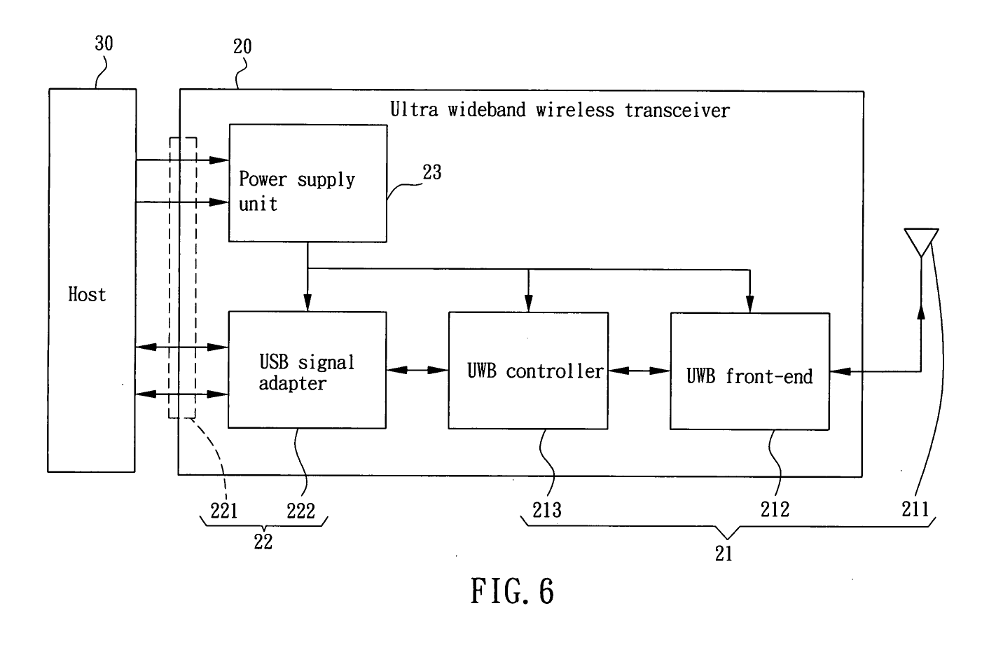

Now referring to FIG. 5 and FIG. 6. FIG. 5 is a diagram of a basic structure of the ultra wideband wireless transceiver and connection status blocks to a host of the present invention. FIG. 6 is a block diagram of a preferred embodiment of internal detailed structure of the ultra wideband wireless transceiver of the present invention. In the preferred embodiment of the present invention as shown in FIG. 5 and FIG. 6, ultra wideband wireless transceiver 20 further comprises: a UWB transceiver module 21, a USB controller module 22, and a power supply unit 23. The UWB transceiver module 21 can transmit or receive wireless UWB signals. USB controlling module 22 is physically connected to UWB transceiver module 21 for converting received UWB signals to USB signal format for the USB compatible devices. Power supply unit 23 inside transceiver 20 accepting power supply from host 30 through the USB interface converts the power required for each module in the transceiver 20.

The UWB transceiver module 21 further comprises: an antenna 211, a UWB front-end 212, and a UWB controller 213. Antenna 211 can be extended from transceiver 20 for strengthening USB signals. UWB front-end 212 is connected to antenna 211 for reducing noise or strengthening antenna 211 signals for transmitting or receiving. UWB controller 213 is connected to the UWB front-end unit 212 and USB controller 22 for modulating USB data to be transmitted to UWB signals or modulating the received UWB signals to USB data.

USB controlling module 22 further comprises: a USB interface 221 disposed at one side of the transceiver 20 for connecting an interface of host 30, and a USB signal adaptor 222 connected to USB interface unit 221 and UWB controlling unit 213 of UWB transceiver module 21 for connecting to the host 30 by the USB connecting interface and transmitting data. Power supply unit 23 is connected to USB interface unit 221 for receiving power supplied by the host 30 through the USB interface.

The following illustrates how to play video/audio files to video output 404 in host 30:

Step 1: the video/audio data of host 30 is first transmitted to ultra wideband wireless transceiver 20 through the USB interface, and then is transmitted to base station 10 using wireless UWB signals by the transceiver 20.

Step 2: UWB module 11 receives the UWB signal through the base station 10, and data processing unit 12 determines which interface port 134 is needed by the output device.

Step 3: bridge module 13 converts the UWB signals to the signals (such as video and audio signals) matching the multimedia protocol and outputs to the corresponding interface port 134. Meanwhile, it is determined whether the multimedia code format needs decoder 133 to speed up operation.

Step 4: finally, electrical signals, which are converted to the corresponding multimedia protocol, are sent to external peripheral devices (such as television screen and sound system) for playing video/audio through video output 404 and speaker 402 of interface port 134.

From the above description, not only can the multifunctional wireless UWB transmission system of the present invention connect to a plurality of peripheral devices using various connections interfaces and protocols across a wireless transmission, an object of host 30 is to have fewer interface ports and controllers to reduce the size of host 30 and also base station 10 to further connect many peripheral devices using various interfaces and protocols such that functionality is substantially improved. In addition, since there are no physical wires between base station 10 and host 30, placement of peripheral devices are not so restricted. Therefore, cables surrounding host 30 are removed which substantially improves the shortcomings of the prior art.

While the invention has been described by way of examples and in terms of the preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures. Accordingly, that above disclosure should be construed as limited only by the metes and bounds of the appended claims.

What is claimed is:

1. A multifunctional ultra wideband (UWB) wireless transmission system comprising a base station which can transmit and receive data with an external host with a means of a wireless UWB protocol and further comprises:
a UWB module for transmitting and receiving a UWB signal;
a bridge module electrically connecting to the UWB transceiver for converting the UWB signal to at least a first protocol and a second protocol of different interfaces;
a data processing module connecting to the UWB module and bridge module providing control of each module and performing related operations and processing; and
a power controller for providing power needed by the base station.

2. The multifunctional UWB wireless transmission system of claim 1, wherein the UWB module further comprises:
an antenna for strengthening the transceiver UWB signal;
a UWB front-end unit connected to the antenna for reducing noise or strengthening the signal of the antenna for transmitting and receiving; and
a UWB controller connecting to the UWB front-end for modulating data of some protocol to be transmitted to a UWB signal or demodulating the received UWB signal to data of the protocol.

3. The multifunctional UWB wireless transmission system of claim 1, wherein the bridge module further comprises:
a USB signal adaptor connecting to the data processing module for converting the UWB signal to the USB protocol for some USB device;
a USB bridge module connected to the USB signal adaptor for converting the USB signal transmitted by the USB signal adaptor to a signal matching the first protocol or second protocol; and
at least one interface port connected to the USB bridge module for connecting to an external peripheral device through the USB bridge module to transmit the signal of first or second protocol.

4. The multifunctional UWB wireless transmission system of claim 3, wherein the first protocol is a protocol supporting one of the following interfaces: audio/video port, serial port, card reader port, Ethernet port, IDE port, parallel port, and 1394 port.

5. The multifunctional UWB wireless transmission system of claim 3, wherein the base station further comprises: a hard disk connecting to the USB bridge module so that the base station functions as a wireless UWB networked hard disk.

6. The multifunctional UWB wireless transmission system of claim 1, wherein the data processor further comprises:
a processor connecting to the bridge module for processing and executing instructions needed for operating the base station; and
a memory unit electrically connecting to the processor for registering operation data and storing files.

7. The multifunctional UWB wireless transmission system of claim 6, wherein the memory unit further comprises:
a read only memory (ROM) connecting to the processor for storing hardware information or instruction sets needed to operate the base station; and
a random access memory (RAM) electrically connecting to the processor for storing registered data or instructions of the processor.

8. The multifunctional UWB wireless transmission system of claim 1, wherein the power controller further comprises:
an alternating current/direct current converter for converting general alternating current (AC) to direct current (DC) needed by the base station; and
a rectification unit connecting to the alternating current/direct current converter for avoiding damages to the base station from an unstable power source.

9. A UWB wireless transmission system comprising a base station which can transmit and receive data with an external host via UWB protocol and further comprises:
a UWB module for transmitting and receiving a UWB signals;
a bridge module electrically connecting to the UWB module for converting the UWB signal to a multimedia format code;
a decoder connected between the bridge module and the interface port for speeding up conversion between the UWB signal and the multimedia format code; and
an interface port connecting to the bridge module which comprises at least an interface port for outputting video and audio.

10. The UWB wireless transmission multifunctional system of claim 9, wherein the multimedia format code can be one of the following: MP3, JPEG, and MP4.

11. The UWB wireless transmission multifunctional system of claim 9, wherein, the bridge module is capable of converting the UWB signal to at least a first protocol and a second protocol of different interfaces in addition to said multimedia format code;
wherein, the UWB module further comprises:
an antenna for strengthening the transceiver UWB signal;
a UWB front-end unit connected to the antenna for reducing noise or strengthening the signal of the antenna for transmitting and receiving; and
a UWB controller connecting to the UWB front-end for modulating data of some protocol to be transmitted to a UWB signal or demodulating the received UWB signal to data of the protocol.

12. The UWB wireless transmission system of claim 11, wherein the bridge module further comprises:
a USB signal adaptor connecting to the data processing module for converting the UWB signal to the USB protocol for some USB device;
a USB bridge module connected to the USB signal adaptor for converting the USB signal transmitted by the USB signal adaptor to a signal matching the first protocol or second protocol; and
at least one interface port connected to the USB bridge module for connecting to an external peripheral device through the USB bridge module to transmit the signal of first or second protocol.

13. A multifunctional UWB wireless transmission system comprising:
a transceiver for connecting to a host which can use the UWB protocol to transmit wireless data; and
a base station using the UWB protocol to facilitate wireless data transmission with the transceiver; the base station further comprising a bridge module and at least one interface port, the bridge module converting a signal of UWB protocol to at least a first protocol of a different interface and transmitting the signal of the first protocol by connecting to at least one external peripheral device through at least one interface port;
wherein the host can perform data transmission with the external peripheral device through the transceiver and base station.

14. The multifunctional UWB wireless transmission system of claim 13, wherein the bridge module further comprises a decoder for speeding up conversion of a multimedia format code.

15. The multifunctional UWB wireless transmission system of claim 13, wherein the chassis of the base station has a functional keypad by which functions of the base station are operated and which further comprises:
a fast setup key for controlling channel setup of the base station; and
a broadcast function key set for directly operating the peripheral device by the base station.

16. The multifunctional UWB wireless transmission system of claim 13, wherein the transceiver further comprises:
a UWB transceiver module for transmitting and receiving wireless UWB signals of the UWB protocol;
a USB controller electrically connecting to the UWB module for converting received UWB signals to a USB signal format meeting the USB interface device; and
a power supply unit receiving power supplied by the host to and converting it for each module in the transceiver.

17. The multifunctional UWB wireless transmission system of claim 16, wherein the UWB transceiver module further comprises:
an antenna;
a UWB front-end unit electrically connecting to the antenna for reducing noise or strengthening the signal of the antenna for transmitting and receiving; and
a UWB controller connecting to the UWB front-end unit and USB controlling module for modulating USB data for transmission to a UWB signal or modulating the received UWB signal to USB data.

18. The multifunctional UWB wireless transmission system of claim 16, wherein the USB controller further comprises:
a USB interface unit disposed at one side of the transceiver for connecting to an interface of the host; and
a USB signal adaptor connecting to the USB interface unit and UWB transceiver module for connecting to the host via the USB connecting interface and data transmission.
